(19) United States
(12) Patent Application Publication
(10) Pub. No.: US 2026/0050499 A1
(43) Pub. Date: Feb. 19, 2026

(54) NUMBER OF USERS FORECAST BASED SCALING OF API AND RESOURCE

(71) Applicant: Kunato Inc., New York, NY (US)

(72) Inventors: Illan POREH, New York, NY (US); MADHUSUDHANAN KRISHNAMOORTHY, Bangalore (IN); CHAIKESH CHOURAGADE, Bangalore (IN)

(21) Appl. No.: 19/299,162

(22) Filed: Aug. 13, 2025

Related U.S. Application Data
(60) Provisional application No. 63/682,381, filed on Aug. 13, 2024.
(60) Provisional application No. 63/682,373, filed on Aug. 13, 2024.

(51) Int. Cl. G06F 9/54; G06N 20/00

(52) U.S. Cl. CPC G06F 9/543; G06N 20/00

(57) ABSTRACT

A method for API scaling the resource for a machine learning engine is disclosed. The method comprises, receiving a request to use the machine learning engine through an API interface, from a user from a plurality of users, forecasting number of users at a geographical location, detecting a surge in the number of users at the geographical location using the forecasted number of users, upon detecting a surge in the number of users at the geographical location, scaling out the API to handle additional load on the machine learning engine at the geographical location, detecting a drop in the number of users at the geographical location using the forecasted number of users, upon detecting a drop in the number of users at the geographical location, scaling in the API to reduce the resource utilization of machine learning engine at the geographical location, and providing the machine learning engine service thorough the API interface, wherein the machine learning module is configured to: determine set of parameters based on internet activities of a user in the plurality of categories, wherein the set of parameters are the content attributes associated with one or more user resonance and overall value ecosystem of a digital content economy, learn the set of parameters to maximize the value function, synchronize one or more specific action outputs using one or more synchronization constraints, maintain coherence among similar entities, wherein the coherence is maintained by comparing a first content genome of a first digital content to a second content genome of a second digital content, optimize a utility function for one or more individual entities, and self-adjust, the reinforcement learning algorithm.

### RELATED APPLICATION DATA

This application claims priority to U.S. Provisional Application Nos. 63/682,381 and 63/682,373, both filed Aug. 13, 2024, the disclosure of which is hereby incorporated by reference in its entirety.

### FIELD OF TECHNOLOGY

The present system relates to the field of machine learning, specifically focusing on reinforcement learning techniques and scaling of the Application Programming API (API) for the reinforcement learning techniques.

### BACKGROUND OF TECHNOLOGY

Reinforcement learning (RL) has emerged as a powerful paradigm within the field of artificial intelligence, enabling intelligent agents to learn optimal decision-making strategies through interaction with an environment. Traditional RL methods have demonstrated success in various applications, including game playing, robotics, and autonomous systems. However, challenges persist in terms of balancing the exploration-exploitation trade-off, handling high-dimensional state spaces, and achieving efficient convergence.

Existing RL techniques often face limitations when applied to complex and adaptive environments, hindering their scalability and adaptability. Furthermore, conventional algorithms may struggle with sample inefficiency and require extensive training data to achieve satisfactory performance. In light of these challenges, there is a recognized need for innovations that can enhance the robustness, speed, and applicability of reinforcement learning systems.

The present invention addresses these challenges by introducing novel methodologies and systems designed to overcome the limitations of traditional RL approaches and also a method to scale the API for the invention across multiple geo-locations. Through advancements in algorithmic techniques, continuous learning, self-adjusting, optimizing, model architectures, or system configurations, the invention aims to propel the field of reinforcement learning towards improved efficiency, adaptability, and real-world applicability.

### SUMMARY OF DESCRIBED SUBJECT MATTER

It is an object or the present disclosure to provide an adaptive reinforcement learning system and method and a scaling API for the adaptive reinforcement learning system. The disclosed adaptive reinforcement learning system as an API may be accessed by one or more users by means or a web or mobile application running on one or more computing devices or the one or more users over a communication network. The disclosed adaptive reinforcement learning system as an appliance may be utilized by the one or more users to perform one or more keywords-based searching for retrieving one or more digital content items from the World Wide Web or one or more databases in real time.

Implement proactive infrastructure scaling based on the CARL model's usage forecast, specifically focusing on the anticipated number of users. Set up predictive auto-scaling mechanisms that leverage historical user data, trends, and seasonality patterns to forecast future user traffic. Integrate the CARL model with predictive analytics tools or machine learning algorithms to generate accurate user traffic forecasts. Utilize these forecasts to preemptively adjust resource allocation, such as provisioning additional servers or containers, in anticipation of expected increases or decreases in user activity. By proactively scaling the infrastructure based on CARL's user traffic forecasts, you can ensure that sufficient resources are available to accommodate anticipated changes in user demand efficiently and effectively. By leveraging CARL, APIs can continuously learn from interactions with the environment and make decisions about scaling resources in real time to maximize performance and efficiency.

In an embodiment of the invention, a method and system is described with the steps of receiving a request to use the machine learning engine through an API interface, from a user from a plurality of users, forecasting number of users at a geographical location, detecting a surge in the number of users at the geographical location using the forecasted number of users, upon detecting a surge in the number of users at the geographical location, scaling out the API to handle additional load on the machine learning engine at the geographical location, detecting a drop in the number of users at the geographical location using the forecasted number of users, upon detecting a drop in the number of users at the geographical location, scaling in the API to reduce the resource utilization of machine learning engine at the geographical location and providing the machine learning engine service thorough the API interface, wherein the machine learning module is configured to: determine set of parameters based on internet activities of a user in the plurality of categories, wherein the set of parameters are the content attributes associated with one or more user resonance and overall value ecosystem of a digital content economy, learn the set of parameters to maximize the value function, synchronize one or more specific action outputs using one or more synchronization constraints, maintain coherence among similar entities, wherein the coherence is maintained by comparing a first content genome of a first digital content to a second content genome of a second digital content, optimize a utility function for one or more individual entities, and self-adjust, the reinforcement learning algorithm.

In an embodiment of the invention, the scaling out the API is a horizontal scaling of the API by deploying one or more additional API endpoints.

In an embodiment of the invention, the forecasting number of users at a geographical location is performed by the machine learning engine using time series forecasting.

In an embodiment of the invention, receiving the request at an API gateway and distributing set of requests to API endpoints by a load balancer.

In an embodiment of the invention, proactively performing the scale out and scale in operations based on the forecast of the number of users.

In an embodiment of the invention, proactively performing the scale out and scale in operations based on the forecast of the user traffic instead of forecast of the number of users.

In an embodiment of the invention, generating bills for a user based on the user traffic on the API.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 illustrates the system architecture in accordance with exemplary embodiments of the disclosed subject matter.

FIG. 2 illustrates the system architecture in accordance with exemplary embodiments of the disclosed subject matter

FIG. 3 is a flowchart of a process in accordance with exemplary embodiments of the disclosed subject matter.

FIG. 4 illustrates a schematic view of the system in accordance with exemplary embodiments of the disclosed subject matter.

FIG. 5 illustrates a schematic view of a component the system in accordance with exemplary embodiments of the disclosed subject matter.

While the present disclosure will be described in connection with the preferred embodiments shown herein, it will be understood that it is not intended to limit the invention to those embodiments. On the contrary, it is intended to cover all alternatives, modifications, and equivalents, as may be included within the spirit and scope of the invention as defined by the appended claims.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

The terms “include,” “have,” and variations thereof, as used herein, have the same meaning as the term “comprise” or appropriate variation thereof. Furthermore, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

The inventors are also aware of the normal precepts of English grammar. Thus, if a noun, term, or phrase is intended to be further characterized, specified, or narrowed in some way, such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

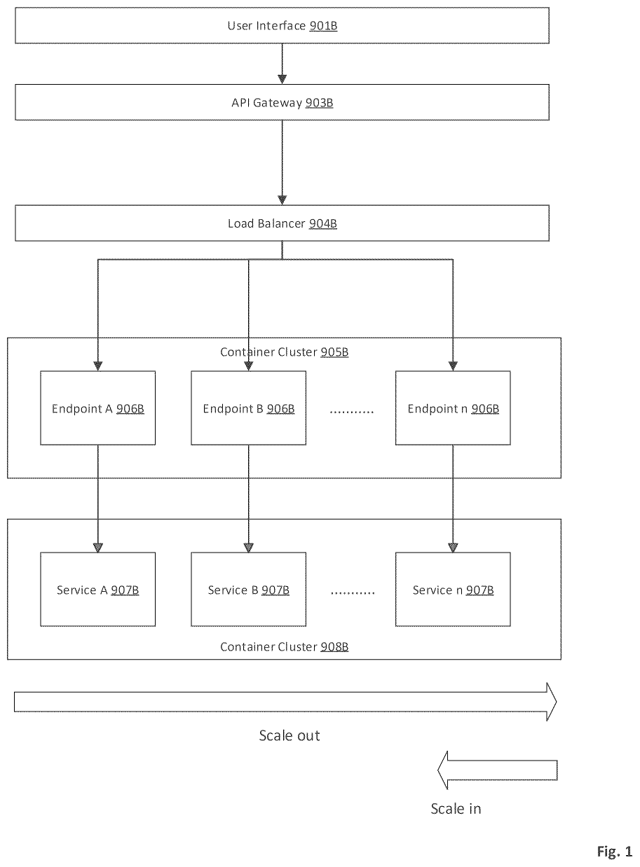

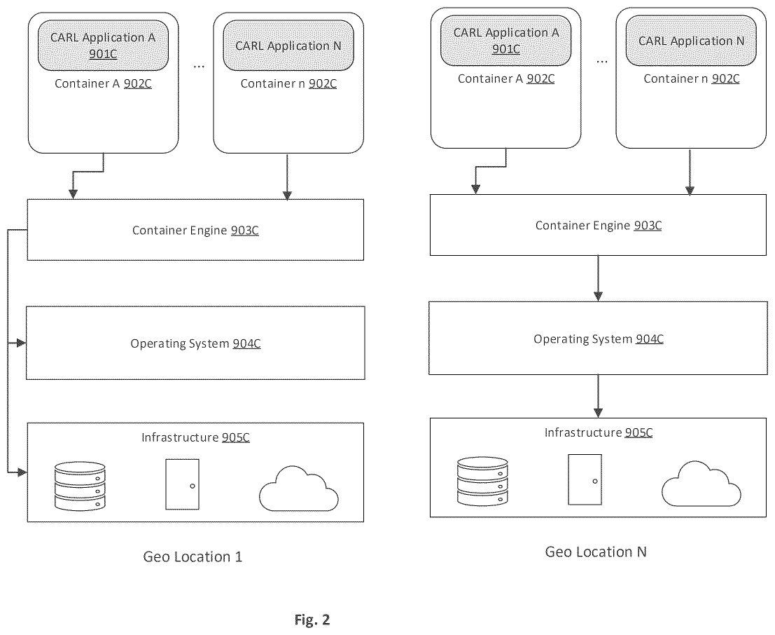

FIGS. 1 and 2 illustrate the architecture of the system, which may include a user interface 901B, an API gateway 903B, a load balancer 904B and container clusters 905B and 908B. Container cluster 905B includes one or more endpoints A through n, referred to herein as endpoints 906B. Container cluster 908B includes one or more services A through n, referred to herein as services 907B. In an exemplary embodiment, scaling out the API is a horizontal scaling of the API by deploying one or more additional API endpoints 906B. Forecasting number of users at a geographical location is performed by the machine learning engine using time series forecasting. A request to use the machine learning engine is received through the user interface 901B and API gateway 903B and distributing set of requests to API endpoints 906B is performed by a load balancer 904B.

The system will proactively perform the scale out and scale in operations based on the forecast of the number of users. Proactively performing the scale out and scale in operations is based on the forecast of the user traffic instead of forecast of the number of users. In an embodiment of the invention, generating bills for a user based on the user traffic on the API.

FIG. 2 illustrates the architecture of the system including infrastructure 905, operating system 904C and container engine 903C, located at each geographic location, e.g., GeoLocation 1 through n. Each container engine 903C may include one or more instances of CARL application 901C in Container 902C.

CARL API scaling operates by continuously monitoring various environmental factors and performance metrics, such as incoming request rates, response times, and resource utilization. Based on this data, the CARL algorithm evaluates the current state of the system and predicts future demand patterns. It then takes actions to scale API resources up or down accordingly to ensure optimal performance and cost-effectiveness.

The adaptive nature of CARL allows it to respond dynamically to changes in workload patterns, traffic spikes, and other environmental factors without the need for manual intervention. By autonomously adjusting resource allocation based on feedback from the environment, CARL API scaling can optimize resource utilization, minimize response times, and enhance overall system resilience and reliability.

Conventional Scaling APIs based on CPU/memory usage or number of users is a well-known practice. These methods rely on reactive heuristics (e.g., “If CPU>80% for 1 min, scale up”) which do not account for the system-wide interplay or user behavioural dynamics.

The system and methods disclosed herein introduces dynamic, synchronization-based, reinforcement learning to both forecast and respond to user surges in a way that adapts across related entities (e.g., microservices or containers). The system and methods described herein include several unconventional technical features.

First, Complex Synchronization Constraint is used herein which penalizes divergence across similar services/containers that serve similar functions or user segments, ensuring system-wide coherence and coordinated scaling rather than independent reactionary scaling.

Second, adaptive Forecast and Real-time Feedback Loop combines real-time feedback (similar to an online learning bandit) with forecasted user behaviours (similar to time-series predictions), creating a hybrid model that is both predictive and responsive.

Third, Inter-Entity Influence Modeling embodies the “everything affects everything” philosophy, using learned correlations between similar APIs/services/users to make holistic decisions about which services to scale, and when.

Fourth, Dual Optimization optimizes for two objectives simultaneously: (1) scaling efficiency (cost/resource), and (2) coherence of container states across similar tasks.

The system and methods described herein forecast the number of users, with emphasis on the novelty of the techniques for such forecasting. The system does not use conventional time-series predictions (like ARIMA or Prophet). Instead, it performs an unconventional combination of Contextual Bandit-Based Learning, Dynamic Propagation Across Entities, Surge Anticipation Via Similar Entity Synchronization, and Multi-Source Adaptive Forecasting. In Contextual Bandit-Based Learning, every user session (and its metadata such as geo, device, timing, history) is treated as a context, and CARL learns the reward (load impact) distribution per context, enabling a probabilistic forecast of demand. Dynamic Propagation Across Entities recognizes that users may have similar behaviors across the entities that they use. For example, suppose Service A sees a surge, and CARL has learned in past that Services A and B tend to be co-used by users. By relying on dynamic propagation across entities, it pre-emptively forecasts a possible surge in B and allocates resources, a behaviour not achievable by traditional LSTM or MAB approaches. Surge Anticipation Via Similar Entity Synchronization recognizes that similarly situated users may exhibit similar behaviors. If several containers tied to similar types of users (e.g., multiple APIs serving high-load countries) are scaling up, CARL projects the “future effect” of the rising pattern across all nodes, acting proactively. Multi-source Adaptive Forecasting relies on historical usage, user behavior, system telemetry, and even environmental events (e.g., holiday calendar, release cycles) to dynamically refine its forecast models.

The system and methods disclosed herein detect surges not solely based on request count thresholds, but through an adaptive anomaly detection framework integrated with reinforcement signals, including an unconventional combination of Surge as Deviation from Synchronized Baseline, Contextual Surge Definition, Lead Indicators of Surge and Lead Indicators of Surge.

Surge as Deviation from Synchronized Baseline flags a sudden divergence in traffic in a cluster of synchronized services as a surge, rather than waiting for hardcoded thresholds. This “group coherence” loss is treated as a reward-punishment signal. Contextual Surge Definition recognizes that an apparent surge should be treated differently in context, e.g., the time of day, mix of users, system state, etc. Accordingly, a 10% traffic rise at midnight is understood as not the same as at noon. Thus surge sensitivity is adjusted based on learned contextual embeddings of such factors as time, user mix, and system state. Real-time Online Learning, using techniques like Vowpal Wabbit and contextual bandits, updates the surge models on-the-fly, allowing it to react to previously unseen surge patterns without retraining. Lead Indicators of Surge allows the system to learn subtle indicators (e.g., spike in API latency, number of open connections, drop in coherence across services) as early warnings, enabling pre-emptive scaling.

Rather than a conventional, naïve one-to-one scaling approach, the system and methods described herein introduce a multi-agent coordination-based scaling approach. By use of Synchronized Scaling, containers are scaled not in isolation but in a synchronized way if their outputs/actions are deemed correlated (based on CARL's similarity constraints). This avoids bottlenecks caused by unbalanced scaling (e.g., front-end scaled, DB not scaled). With Adaptive Scaling Policy as a Learned Function: the system learns the policy that maps environmental states and forecasted demand to scaling actions. This is not a rules-based auto scaler but a learned optimizer that continuously refines its policy via feedback loops. Cost-Aware and Revenue-Aware Scaling does not merely optimize for load balancing, but rather learns to optimize container allocation in a way that balances computational cost with business priorities (e.g., prioritizing APIs with higher customer value). A Self-Healing Feedback Loop considers whether a scaling decision causes resource contention or fails to meet SLAs, and then feeds the negative outcome back into the policy refinement, allowing it to avoid similar missteps in future.

The systems and methods described herein provide technical benefits that overcome the difficulties inherent to conventional scaling techniques. A challenge posed by conventional systems is Real-time Coherence Enforcement, such that synchronization constraints must be enforced in real-time across containers. This increases latency and complexity. The system and methods described herein use vectorized representations of entity similarity to enforce constraints during policy evaluation, leveraging optimized parallel processing. Another challenge is Model Stability vs. Adaptability, such that CARL must adapt quickly without overfitting to noisy user behaviour. Mitigation of this challenge is provided by the use of regularized online learning, experience replay for stability and fast adaptation. Another challenge of conventional systems is the Scalability of RL Decisions, in which RL agents must act across thousands of microservices. The systems and methods described herein employ hierarchical decision-making: global policy learns high-level strategy, local agents to make fine-grained decisions. The challenge of Cold Start and Drift in conventional systems may occur when new services or unobserved patterns can derail scaling. In mitigation, CARL uses contextual similarity mapping to transfer learned policies from similar entities, thus bootstrapping cold starts. Conventional systems typically suffer from a lack of Explaining Scaling Actions when RL-based decisions are often black-box. The system and methods described herein incorporates SHAP values, attention-based logs to attribute cause of scaling (e.g., “user surge from SEA+CPU spike on Node-4”). Conventional systems struggle with Compliance with Business Constraints Scaling, in which users must respect cost budgets, SLAs, legal constraints. The system and methods described herein encode constraints in the reward function and penalized as policy violations during learning.

Set up auto-scaling mechanisms in your cloud infrastructure (e.g., AWS Auto Scaling, Kubernetes Horizontal Pod Autoscaler) to automatically add or remove API instances based on the decisions recommendation made by the CARL algorithm for a specific geo-location.

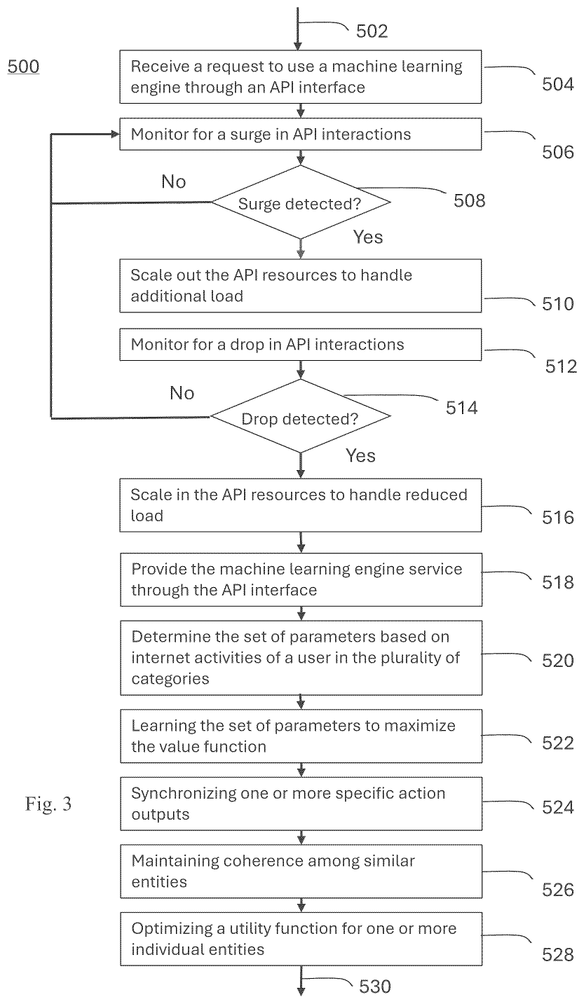

In an embodiment of the invention, a process flow 500 is illustrated in FIG. 3. Beginning at Step 502, a request is received to use the machine learning engine through an API interface, from a user from a plurality of users, forecasting number of users at a geographical location. (Step 504) It is understood that the various steps described herein are not necessarily sequential unless one step is required to be completed before the next step is commenced.

At step 506, the system monitors for a surge in API interactions with digital content based on multiple factors at a specific geographic-location, including forecasting the number of users at a geographic location. At step 508, if a surge is detected, e.g., the number of users at the geographical location is detected using the forecasted number of users, upon detecting the surge in the number of users at the geographical location, scaling out the API to handle additional load on the machine learning engine at the geographical location occurs at step 510. If no surge is detected, the process flow returns to step 504, continuing to monitor.

At step 512, the system monitors for a drop in API interactions with digital content, based on multiple factors at a specific geographic location, including forecasting the number of users at a geographic location. At step 514, if a drop in the number of users at the geographical location is detected using the forecasted number of users, upon detecting a drop in the number of users at the geographical location, scaling in the API to reduce the resource utilization of machine learning engine at the geographical location occurs at step 516. If no drop is detected, the flow returns to step 504, continuing the monitoring step.

At step 518, the machine learning engine is provided service thorough the API interface, wherein the machine learning module is configured to performed a number of steps:

At step 528, a utility function is optimized for one or more individual entities, and self-adjust, the reinforcement learning algorithm. The process ends at 530.

At step 520, the set of parameters based on internet activities of a user in the plurality of categories is determined, wherein the set of parameters are the content attributes associated with one or more user resonance and overall value ecosystem of a digital content economy. In some embodiments, this includes deriving weights or configurations based on input data and history. The step is performed, e.g., by the CARL Application instance 901C, illustrated in Container 902C (See FIG. 2.) The core RL unit determines reward functions, policy parameters, and learning rates based on current state, environment feedback, and metadata inputs.

At step 522, the set of parameters to maximize the value function is learned. This step uses RL to learn a policy that maximizes cumulative reward. The function of maximizing the value function is performed, e.g., by the CARL Application instance 901C, illustrated in Container 902C (See FIG. 2.). The application learns a policy π that maximizes expected cumulative reward over time; employs reward shaping and dynamic objective updates. In an exemplary embodiment, DDPG (Deep Deterministic Policy Gradient) is used with two architectural enhancements: Noise-injected exploration policy via Ornstein-Uhlenbeck process for smoother continuous control, and a soft update of target networks to stabilize training over volatile behavioral logs. Additionally, for discrete state clusters, Proximal Policy Optimization (PPO) is used where action space maps to behavioral nudges (e.g., recommend, suppress, personalize). Learning is edge-adaptive, e.g., model weights are synced with a central model only when KL divergence between local and global models exceeds a defined threshold.

At step 524, one or more specific action outputs are synchronized using one or more synchronization constraints. This refers to aligning decisions for similar inputs. In accordance with exemplary embodiments, synchronization refers to real-time orchestration of multi-modal content actions, not just time alignment. It is executed via a constraint-checking middleware, e.g., synchronizer module (logical unit within CARL) that aligns or harmonizes actions across similar content/entities, and ensures temporal, semantic, or contextual coherence. In an exemplary embodiment, constraints include a (1) latency_window in which actions must execute within a tolerance band across containers (e.g., 150 ms); (2) behavioral state alignment, e.g., if one module detects “exploratory” mode, all others switch to low-repetition content suggestions, and (3) device-aware delivery, in which sync rules vary if user is on mobile vs. desktop (e.g., image-heavy outputs are deprioritized on mobile). In practice, each action-producing module writes to a shared temporal buffer tagged with a synchronization key. Only when all keys resolve within the window does the action chain execute.

At step 526, the machine learning module maintains coherence among similar entities, e.g., policy coordination across clusters, wherein the coherence is maintained by comparing a first content genome of a first digital content to a second content genome of a second digital content, e.g., political news and related opinion articles are treated similarly. In accordance with an exemplary embodiment, coherence is semantic, not temporal. Each digital content object is encoded into a content genome, e.g., a multi-dimensional feature vector (˜1024 dims) including one or more of an entity set; sentiment polarity; actual density; narrative arc length; and source credibility score. These are compared via cosine similarity and Jaccard topic overlap to ensure non-redundancy (e.g., two similar articles aren't shown back-to-back) and non-contradiction (e.g., contradictory headlines not delivered in the same session). This coherence layer works downstream of synchronization and enforces semantic alignment across delivered artifacts. In some embodiments, this is implemented in an indexer application instance and synchronizer module, such that indexer clusters similar inputs (based on embeddings) and synchronizer ensures consistent actions (e.g., pricing or publishing cadence) across those clusters

At step 528, the machine learning module optimizes a utility function for one or more individual entities. Optimization drives the agent to act towards a defined goal. The utility function varies by system goal (e.g., engagement, revenue, trust). In an exemplary embodiment, optimization is done using a multi-objective RL controller with weighted rewards. An exemplary process includes assigning scores to user actions (click, share, dismiss, ignore) via pre-trained reward models; using TD3 (Twin Delayed DDPG) for reward optimization with less overestimation bias; and integrating multi-arm bandit layer to dynamically switch focus between utility objectives based on session characteristics. Optimization function is implemented at the CARL Application instance and Utility evaluator (logical evaluator within policy loop) that performs Custom utility functions (e.g., engagement*reach/cost) are optimized per deployment via feedback loops, tuning weights dynamically. The process ends at step 530.

In an embodiment of the invention, the scaling out the API is a horizontal scaling of the API by deploying one or more additional API endpoints. In an embodiment of the invention, the forecasting number of users at a geographical location is performed by the machine learning engine using time series forecasting. In an embodiment of the invention, receiving the request at an API gateway and distributing set of requests to API endpoints by a load balancer. In an embodiment of the invention, proactively performing the scale out and scale in operations based on the forecast of the number of users. In an embodiment of the invention, proactively performing the scale out and scale in operations based on the forecast of the user traffic instead of forecast of the number of users. In an embodiment of the invention, generating bills for a user based on the user traffic on the API.

In contrast to existing models, such as Large Language Model (LLM), which operate with static databases, the CARL API function in a real-time, dynamic, and intricately complex ecosystem, managing an ever-changing and vast fluid dataset. Every second, it seamlessly processes interactions from millions of users, accurately recalibrating the values and prices of numerous content items in real-time. This capability to process, scale, maintain credibility, and ensure equitability and fairness represents a groundbreaking advancement in AI science. Such a model holds the potential for adaptation across various sectors and solutions, particularly in addressing complex, dynamic, and real-time adaptive scenarios.

This comparison forms part of a real-time recursive model utilizing Adaptive Reinforcement Learning, ensuring market equilibrium and fairness. Therefore, even if individual content weights are adjusted, the overall impact on the pricing system is minimized. It's worth noting that Deep RL systems are not typically designed for real-time adaptation in rapidly changing environments. While they can make decisions in real time, their underlying policy does not adapt in real time to changing circumstances or events.

The invention introduces a unique feature called “one thing influencing many events simultaneously”, wherein a singular factor has the capability to influence numerous events simultaneously. Unlike conventional systems where individual parameters are adjusted independently, this innovation incorporates a holistic approach, allowing a single element to exert a cascading effect across multiple events concurrently. This synchronized influence enhances the efficiency and coherence of the system, enabling a unified response to various interconnected aspects. In the context of Real-Time AI, this means that a single influential factor can dynamically impact numerous aspects of the system concurrently, providing a more comprehensive and streamlined approach to decision-making in complex, interconnected scenarios. This novel capability represents a significant advancement in the field, offering a more integrated and efficient solution for handling real-time, multifaceted data interactions.

The invention introduces a unconventional concept characterized by the generation of massive ripple effects within the system. Unlike traditional models where adjustments to individual components have localized impacts, this innovation triggers expansive and interconnected consequences across the entire system. In the context of Real-Time AI, a small modification or input can lead to cascading effects, influencing a multitude of events on a grand scale. This dynamic ripple effect ensures that changes propagate swiftly and comprehensively throughout the system, creating a highly responsive and adaptive environment. This novel feature enhances the system's ability to handle intricate, real-time scenarios by enabling the simultaneous consideration of numerous interrelated factors, leading to a more synchronized and efficient decision-making process.

In an embodiment of the invention, a method and system for providing an Application Programming Interface (API) involves receiving requests from client applications and providing access to resources or services via standardized interfaces. The API system includes modules for request handling, authentication, and data processing. Upon receiving a request, the API processes the request parameters, validates user credentials, and routes the request to the appropriate service or resource. The API may support various protocols such as HTTP, REST, or GraphQL, allowing clients to interact with backend systems in a secure and efficient manner. Furthermore, the API system includes monitoring and logging capabilities to track usage metrics and diagnose performance issues. This API technology enables developers to integrate third-party services, access data securely, and build scalable applications with case.

Forecasting number of users using ML is performed by choosing an appropriate machine learning algorithm for forecasting user numbers based on the characteristics of the data and the forecasting task. Common algorithms for time series forecasting could be used. The selected machine learning model is trained using the training data. Model hyperparameters are adjusted as needed to optimize performance. The model is tuned to capture seasonality, trends, and other patterns in the user data. The trained model's performance is evaluated on the testing data using appropriate evaluation metrics such as Mean Absolute Error (MAE), Mean Squared Error (MSE), Root Mean Squared Error (RMSE), or Mean Absolute Percentage Error (MAPE). The trained model is used to make predictions of future user numbers based on new or unseen data. Forecasts for the desired time horizon are generated, considering factors such as seasonality, trend changes, and external influences. By leveraging machine learning for user forecasting, organizations can anticipate future demand, allocate resources efficiently, and make informed business decisions to meet the needs of their user base.

The API usage is forecast based scaling of resource. The system and methods described herein include a sophisticated mechanism for scaling the CARL API based on projected API usage. This approach ensures that the system can dynamically adjust resource allocation to meet varying demands, optimizing performance and efficiency. The scaling mechanism utilizes machine learning algorithms to forecast the number of API calls based on historical usage data, current trends, and predicted user activity. These forecasts enable the system to anticipate high-traffic periods and adjust the resources allocated to the API accordingly.

The process begins with the continuous collection of API usage data, which includes metrics such as the number of requests, response times, and user engagement patterns. This data is fed into the machine learning model, which analyzes it to identify patterns and trends that can predict future usage.

Based on the projections generated by the machine learning model, the system dynamically adjusts the number of API instances and the amount of compute and storage resources available. This ensures that the API can handle the projected load without degradation in performance. During anticipated peak usage times, additional resources are provisioned in advance to accommodate the expected increase in API calls. Conversely, during periods of low activity, resources are scaled down to optimize cost-efficiency without compromising user experience.

The system also incorporates real-time monitoring and feedback loops to continually refine the projections and scaling decisions. By continuously comparing actual usage against forecasts, the machine learning model can be updated to improve accuracy over time.

Additionally, the scaling mechanism supports both vertical and horizontal scaling. Vertical scaling involves increasing the capacity of existing resources, while horizontal scaling involves adding more instances of the API. This dual approach allows the system to scale efficiently based on the nature of the projected demand.

The integration of usage projection-based scaling ensures that the CARL API remains responsive and reliable, even under varying load conditions. It minimizes the risk of over-provisioning or under-provisioning resources, thereby optimizing both performance and operational costs.

This proactive scaling strategy is particularly beneficial for maintaining service quality during unexpected spikes in usage, such as during major product launches or promotional events. By forecasting demand and adjusting resources accordingly, the system can provide a seamless and uninterrupted user experience.

In summary, the usage projection-based scaling mechanism leverages advanced machine learning techniques to predict API demand and dynamically allocate resources. This ensures that the CARL API can efficiently handle fluctuating usage patterns, delivering optimal performance and reliability to its users.

CARL engine is scaled based on projected usage. This approach ensures that the system can dynamically adjust resource allocation to meet varying demands, optimizing performance and efficiency of the CARL engine itself. Similar to the API scaling mechanism except as where noted, the scaling of the CARL engine utilizes machine learning algorithms to forecast the number of operations based on historical usage data, current trends, and predicted activity. These forecasts enable the system to anticipate high-traffic periods and adjust the resources allocated to the CARL engine accordingly.

The process begins with the continuous collection of operational data from the CARL engine, which includes metrics such as the number of processing requests, execution times, and system load patterns. This data is fed into the machine learning model, which analyzes it to identify patterns and trends that can predict future usage.

Based on the projections generated by the machine learning model, the system dynamically adjusts the computational resources and infrastructure capacity dedicated to the CARL engine. This ensures that the CARL engine can handle the projected load without degradation in performance.

During anticipated peak usage times, additional resources are provisioned in advance to accommodate the expected increase in processing demands. Conversely, during periods of low activity, resources are scaled down to optimize cost-efficiency without compromising the performance of the CARL engine.

The system also incorporates real-time monitoring and feedback loops to continually refine the projections and scaling decisions for the CARL engine. By continuously comparing actual operational data against forecasts, the machine learning model can be updated to improve accuracy over time.

Additionally, the scaling mechanism for the CARL engine supports both vertical and horizontal scaling. Vertical scaling involves increasing the capacity of existing computational resources, while horizontal scaling involves adding more processing instances. This dual approach allows the system to scale efficiently based on the nature of the projected demand.

The integration of usage projection-based scaling for the CARL engine ensures that it remains responsive and reliable, even under varying load conditions. It minimizes the risk of over-provisioning or under-provisioning resources, thereby optimizing both performance and operational costs of the CARL engine.

This proactive scaling strategy is particularly beneficial for maintaining service quality during unexpected spikes in processing demands, such as during intensive data analysis or model training periods. By forecasting demand and adjusting resources accordingly, the system can provide seamless and uninterrupted performance of the CARL engine.

The present invention also includes a premium API subscription plan designed to offer enhanced resource allocation and performance for subscribers. This plan caters to users with higher demands and requires more consistent, high-quality service. By subscribing to the premium plan, users benefit from prioritized access to API resources, ensuring superior performance and reliability even during peak usage times. The premium API subscription plan incorporates several key features to enhance user experience and service quality. Subscribers receive a higher allocation of compute and storage resources, reducing latency and improving response times for their API calls. This is achieved by allocating dedicated API instances and leveraging advanced load balancing techniques to ensure optimal performance.

The resource allocation for premium subscribers is dynamically managed through the CARL API's scaling mechanisms. Premium users are monitored separately to ensure their needs are met without compromising the service quality for standard users. The system utilizes machine learning algorithms to predict the resource requirements of premium subscribers, adjusting the allocation proactively to maintain consistent performance.

Additionally, the premium plan includes enhanced support services, offering faster response times and dedicated technical support to address any issues or queries promptly. This ensures that premium subscribers can rely on a higher level of service availability and support, contributing to a more robust and reliable API usage experience.

The integration of the premium API subscription plan with the CARL API's dynamic scaling infrastructure allows for efficient and effective resource management. By forecasting the usage patterns and demands of premium subscribers, the system can allocate resources more accurately, ensuring that premium users experience minimal latency and maximum uptime.

The premium API subscription plan also provides additional features such as advanced analytics, custom reporting, and personalized configuration options. These tools enable premium subscribers to gain deeper insights into their API usage, optimize their application performance, and tailor the service to their specific needs.

In summary, the premium API subscription plan leverages the CARL API's advanced resource allocation and scaling capabilities to deliver a superior service experience. By providing dedicated resources, enhanced support, and advanced features, the premium plan ensures that high-demand users receive the performance and reliability they require, making it an attractive option for businesses and developers with critical API usage needs.

In another embodiment, the present invention includes a resource scaling mechanism for the CARL engine that not only optimizes performance and efficiency but also ensures compliance with data privacy regulations such as the General Data Protection Regulation (GDPR) and the California Consumer Privacy Act (CCPA). This approach guarantees that the system adheres to stringent data privacy requirements while dynamically adjusting resource allocation based on projected usage.

The resource scaling mechanism begins with the collection of operational data from the CARL engine, similar to the previous embodiment except where the differences are noted. This data includes metrics such as processing requests, execution times, and system load patterns. However, additional data privacy considerations are incorporated into the process.

The system employs privacy-preserving techniques, such as data anonymization and encryption, to ensure that any personally identifiable information (PII) is protected during the collection and analysis phases. The machine learning model used for forecasting operational demand is designed to operate on this anonymized and encrypted data, thereby maintaining compliance with GDPR and CCPA requirements.

Based on the privacy-compliant forecasts generated by the machine learning model, the system dynamically adjusts the computational resources and infrastructure capacity dedicated to the CARL engine. This includes provisioning resources in specific geographic locations to comply with data residency requirements outlined by GDPR and CCPA.

During anticipated peak usage times, additional resources are provisioned in advance, ensuring they meet the necessary data privacy standards. For instance, resources located in regions with strict data protection laws are prioritized for handling sensitive data, while ensuring that overall system performance is not compromised.

The system also incorporates real-time monitoring and feedback loops to continually refine the projections and scaling decisions. Privacy impact assessments (PIAs) are conducted periodically to evaluate the effectiveness of data privacy measures and ensure ongoing compliance with GDPR and CCPA.

To further enhance data privacy, the scaling mechanism supports federated learning, where the machine learning model is trained across multiple decentralized devices or servers holding local data samples, without exchanging the data itself. This ensures that sensitive information remains within its original location, reducing the risk of data breaches and enhancing privacy.

The resource scaling strategy includes both vertical and horizontal scaling while adhering to data privacy requirements. Vertical scaling involves increasing the capacity of existing resources with strong data protection measures, while horizontal scaling involves adding more instances in compliant regions to handle increased demand.

By integrating data privacy considerations into the resource scaling mechanism, the system ensures that it remains responsive and reliable while fully compliant with GDPR and CCPA. This minimizes the risk of regulatory violations and enhances trust with users who are concerned about the privacy of their data.

The proactive scaling strategy, combined with robust data privacy measures, ensures seamless and uninterrupted performance of the CARL engine, even during periods of high demand. This approach not only optimizes operational efficiency but also reinforces the system's commitment to protecting user data.

In summary, this embodiment of the resource scaling mechanism for the CARL engine leverages advanced machine learning techniques to predict operational demand and dynamically allocate resources while ensuring compliance with data privacy regulations such as GDPR and CCPA. This guarantees that the CARL engine can efficiently handle fluctuating processing loads while maintaining the highest standards of data privacy and protection.

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized for monitoring user activity and determining values for any items or objects in real-time.

A content item may be any type of digital or electronic item or object (e.g., document, web page, file, data object, etc.) containing any type, or a combination of any types, of data (e.g., text, multimedia, video, audio, image, streaming data, etc.). For example, a content item may include a news or other article, a web site or page, a paper, a document, program code or an application, an audio recording, a video, an image, a live or recorded podcast, streaming media, streaming media of a live event, a blog, a message, a chat, a conversation or other thread, any combination thereof, etc.

The classification may be performed by any conventional or other machine learning models (e.g., mathematical/statistical; classifiers; feed-forward, deep learning, recurrent, convolutional or other neural networks; unsupervised, supervised, or semi-supervised; etc.). The machine learning model may use unsupervised or supervised learning. Unsupervised machine learning uses data that has not been labeled, classified, or categorized. For example, an unsupervised machine learning model (e.g., neural network, etc.) may be trained with a training set of unlabeled data, where the neural network attempts to produce the provided data and uses an error from the output (e.g., difference between inputs and outputs) to adjust weight (and bias) values. A supervised machine learning model (e.g., neural network, etc.) may be trained with a training set including input and known output, where the neural network attempts to produce the provided output and uses an error from the output (e.g., difference between produced and known outputs) to adjust weight (and bias) values (e.g., via backpropagation or other training techniques).

The activity may include any online or other activities by any entity with respect to content items (e.g., clicks to access/initiate a transaction, cursor hover time, selection of content items, views of advertisements, etc.). The measurements or observations for the activity may include any desired information (e.g., quantity of clicks to access/initiate a transaction, amount of cursor hover time, quantity of selections of content items, quantity of views of advertisements, quantity of purchase or other transactions, etc.).

Having described preferred embodiments of a new and improved system, method, and computer program product for monitoring online activity for real-time ranking of content, it is believed that other modifications, variations and changes will be suggested to those skilled in the art in view of the teachings set forth herein. It is therefore to be understood that all such variations, modifications and changes are believed to fall within the scope of present invention embodiments

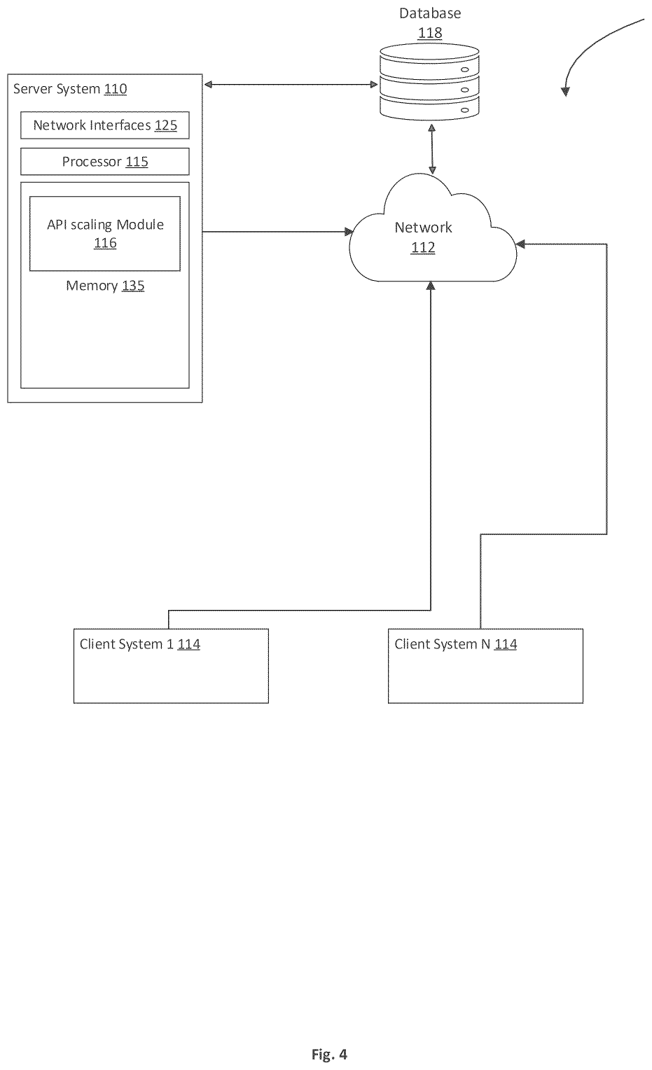

In some embodiments, referring to FIG. 4, platform 100 includes a server system 110 and a database 118. One or more client systems, e.g., client device 1 114 through client device N 114, sometimes referred to as client devices 114, are connected to the server system 110 via network 112. Client devices 114 of the exemplary computer-based system and platform 100 may include virtually any computing device capable of receiving and sending a message over a network (e.g., cloud network), such as network 112, to and from another computing device, such as server system 110, each other, and the like. In some embodiments, the system server 100 and/or client devices 114 may be personal computers, multiprocessor systems, microprocessor-based or programmable consumer electronics, network PCs, and the like. In some embodiments, the system server 100 and one or more client devices 114 may include computing devices that typically connect using a wireless communications medium such as cell phones, smart phones, pagers, walkie talkies, radio frequency (RF) devices, infrared (IR) devices, citizens band radio, integrated devices combining one or more of the preceding devices, or virtually any mobile computing device, and the like. In some embodiments, the system server 100 and/or one or more clients 114 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, system server 110 and/or one or more client devices 114 may include may run one or more applications, such as Internet browsers, mobile applications, voice calls, video games, videoconferencing, and email, among others. In some embodiments, the system server 100 and/or one or more client devices 114 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, the system server 100 and/or client devices 114 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, the system server 100 and/or client devices 144 may periodically report status or send alerts over text or email. In some embodiments, the system server 100 and/or client devices 144 may contain a data recorder which is remotely downloadable by the user using network protocols such as FTP, SSH, or other file transfer mechanisms. In some embodiments, a member device may provide several levels of user interface, for example, advance user, standard user. In some embodiments, the system server 100 an/or client devices 144 and/or one or more clients 114 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, exemplary network 112 may provide network access, data transport and/or other services to any computing device coupled to it. In some embodiments, the exemplary network 112 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 112 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 112 may include and implement, as an alternative or in conjunction with one or more of the above, a WiMAX architecture defined by the WiMAX forum. In some embodiments and, optionally, in combination of any embodiment described above or below, the exemplary network 112 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 112 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 112 may also include mass storage, such as network attached storage (NAS), a storage area network (SAN), a content delivery network (CDN) or other forms of computer or machine readable media.

In some embodiments, the server system 110 may include a web server (or a series of servers) running a network operating system, examples of which may include but are not limited to Apache on Linux or Microsoft IIS (Internet Information Services). In some embodiments, the server system 110 may be used for and/or provide cloud and/or network computing. Although not shown in FIG. 1, some embodiments, the exemplary network 112 may have connections to external systems like email, SMS messaging, text messaging, ad content providers, etc.

In some embodiments, one or more of the exemplary network 112 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the server system 110 and client devices 114.

In some embodiments and, optionally, in combination of any embodiment described above or below, for example, one or more client devices 114 and the server system 110 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

FIG. 4 depicts a block diagram of the server system 110 in accordance with one or more embodiments of the present disclosure. In some embodiments, the server system 110 includes a computer-readable medium 135, such as a random-access memory (RAM) coupled to a processor 115 or FLASH memory. In some embodiments, the processor 115 may execute computer-executable program instructions stored in memory 135. In some embodiments, the processor 115 may include a microprocessor, an ASIC, and/or a state machine. In some embodiments, the processor 115 may include, or may be in communication with, media, for example computer-readable media, which stores instructions that, when executed by the processor 115, may cause the processor 115 to perform one or more steps described herein. System server 110 further includes the CARL appliance management module 116. In some embodiments, examples of computer-readable media may include, but are not limited to, an electronic, optical, magnetic, or other storage or transmission device capable of providing a processor, such as the processor of client device 114, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc. The server system 110 further includes a network interface 125 by any wired or wireless protocols known in the art.

In some embodiments, client devices 114 may also comprise a number of external or internal devices such as a mouse, a CD-ROM, DVD, a physical or virtual keyboard, a display, or other input or output devices. In some embodiments, examples of client devices 114 may be any type of processor-based platforms that are connected to a network 112 such as, without limitation, personal computers, digital assistants, personal digital assistants, smart phones, pagers, digital tablets, laptop computers, Internet appliances, and other processor-based devices. In some embodiments, client devices 114 may be specifically programmed with one or more application programs in accordance with one or more principles/methodologies detailed herein. In some embodiments, client devices 114 may operate on any operating system capable of supporting a browser or browser-enabled application, such as Microsoft™, Windows™, and/or Linux. In some embodiments, client devices 114 may include, for example, personal computers executing a browser application program such as Microsoft Corporation's Internet Explorer™, Apple Computer, Inc.'s Safari™, Mozilla Firefox, and/or Opera. In some embodiments, client devices 114 may communicate over the exemplary network 112 with each other and/or with other systems and/or devices coupled to the network. Client devices 114 may include a processor as well as memory, not shown. In some embodiments, the system server 110 and the one or more client devices 114 may be mobile devices. As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

In some embodiments, advertisement placement critically includes geographical information to maximize value. Accordingly, terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For case, at times the above variations are not listed or are only partially listed; this is in no way meant to be a limitation.

In some embodiments, at least one database 118 of exemplary databases may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

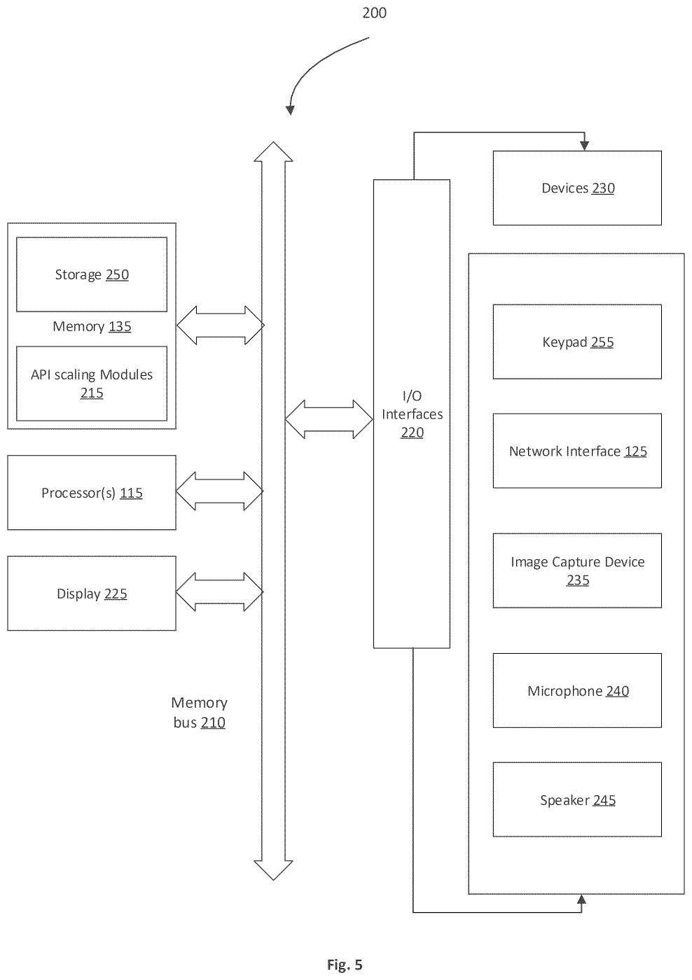

FIG. 5 is a further schematic view of the device 200, that can refer to system server 110 as discussed above. Each exemplary device 200 includes a processor 114, memory 135 and display 225. The memory 135, as discussed above, includes storage 250 and a CARL appliance management module 215. Device 200 further includes I/O interfaces 220 for connecting devices 230, keypad 225, network interface 125, image capture device 235, microphone 240 and speaker 245 to the processor 115, memory 135 and display 225 via a memory bus 210.

In some embodiments, the exemplary inventive computer-based systems/platforms, the exemplary inventive computer-based devices, and/or the exemplary inventive computer-based components of the present disclosure may be specifically configured to operate in a cloud computing/architecture such as, but not limiting to: infrastructure a service (IaaS) 910, platform as a service (PaaS), and/or software as a service (SaaS) using a web browser, mobile app, thin client, terminal emulator or other endpoint.

It is to be understood that the software of the present invention embodiments may be implemented in any desired computer language and could be developed by one of ordinary skill in the computer science based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized for monitoring user activity and determining values for any items or objects in real-time.

A content item may be any type of digital or electronic item or object (e.g., document, web page, file, data object, etc.) containing any type, or a combination of any types, of data (e.g., text, multimedia, video, audio, image, streaming data, etc.). For example, a content item may include a news or other article, a web site or page, a paper, a document, program code or an application, an audio recording, a video, an image, a live or recorded podcast, streaming media, streaming media of a live event, a blog, a message, a chat, a conversation or other thread, any combination thereof, etc.

The classification may be performed by any conventional or other machine learning models (e.g., mathematical/statistical; classifiers; feed-forward, deep learning, recurrent, convolutional or other neural networks; unsupervised, supervised, or semi-supervised; etc.). The machine learning model may use unsupervised or supervised learning. Unsupervised machine learning uses data that has not been labeled, classified, or categorized. For example, an unsupervised machine learning model (e.g., neural network, etc.) may be trained with a training set of unlabeled data, where the neural network attempts to produce the provided data and uses an error from the output (e.g., difference between inputs and outputs) to adjust weight (and bias) values. A supervised machine learning model (e.g., neural network, etc.) may be trained with a training set including input and known output, where the neural network attempts to produce the provided output and uses an error from the output (e.g., difference between produced and known outputs) to adjust weight (and bias) values (e.g., via backpropagation or other training techniques).

The activity may include any online or other activities by any entity with respect to content items (e.g., clicks to access/initiate a transaction, cursor hover time, selection of content items, views of advertisements, etc.). The measurements or observations for the activity may include any desired information (e.g., quantity of clicks to access/initiate a transaction, amount of cursor hover time, quantity of selections of content items, quantity of views of advertisements, quantity of purchase or other transactions, etc.).

The disclosed subject matter introduces an advanced AI module or a set of AI modules by incorporating AI into the placement of advertisements brings benefits in terms of scalability, efficiency, and personalization. It allows for the placement of a large number of unique, tailored advertisements in real-time, matching the digital content. Furthermore, the AI module can learn from user engagement data to continuously improve the placement of the advertisements.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24).NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A method for API scaling the resource for a machine learning engine comprising:
receiving a request to use the machine learning engine through an API interface, from a user from a plurality of users;
forecasting number of users at a geographical location;
detecting a surge in the number of users at the geographical location using the forecasted number of users;
upon detecting a surge in the number of users at the geographical location, scaling out the API to handle additional load on the machine learning engine at the geographical location;
detecting a drop in the number of users at the geographical location using the forecasted number of users;
upon detecting a drop in the number of users at the geographical location, scaling in the API to reduce the resource utilization of machine learning engine at the geographical location; and
providing the machine learning engine service thorough the API interface, wherein the machine learning module is configured to:
determine set of parameters based on internet activities of a user in the plurality of categories, wherein the set of parameters are the content attributes associated with one or more user resonance and overall value ecosystem of a digital content economy;
learn the set of parameters to maximize the value function;
synchronize one or more specific action outputs using one or more synchronization constraints;
maintain coherence among similar entities, wherein the coherence is maintained by comparing a first multi-dimensional content feature vector of a first digital content to a second multi-dimensional content feature vector of a second digital content;
optimize a utility function for one or more individual entities; and self-adjust, the reinforcement learning algorithm.

2. The method of claim 1, wherein the scaling out the API is a horizontal scaling of the API by deploying one or more additional API endpoints.

3. The method of claim 2, wherein forecasting number of users at a geographical location is performed by the machine learning engine using time series forecasting.

4. The method of claim 3, further comprises receiving the request at an API gateway and distributing set of requests to API endpoints by a load balancer.

5. The method of claim 4, further comprises proactively performing the scale out and scale in operations based on the forecast of the number of users.

6. The method of claim 4, further comprises proactively performing the scale out and scale in operations based on the forecast of the user traffic instead of forecast of the number of users.

7. The method of claim 6, wherein generating bills for a user based on the user traffic on the API.

8. A system for API scaling the resource for a machine learning engine comprising: a processor configured to:
receive, via the processor, a request to use the machine learning engine through an API interface, from a user from a plurality of users;
forecast, by the processor, number of users at a geographical location;
detect, by the processor, a surge in the number of users at the geographical location using the forecasted number of users;
upon detecting a surge in the number of users at the geographical location, scale, by the processor, out the API to handle additional load on the machine learning engine at the geographical location;
detect, by the processor, a drop in the number of users at the geographical location using the forecasted number of users;
upon detecting a drop in the number of users at the geographical location, scale, by the processor, in the API to reduce the resource utilization of machine learning engine at the geographical location; and
provide, by the processor, the machine learning engine service thorough the API interface, wherein the machine learning module is configured to:
determine set of parameters based on internet activities of a user in the plurality of categories, wherein the set of parameters are the content attributes associated with one or more user resonance and overall value ecosystem of a digital content economy;
learn the set of parameters to maximize the value function;
synchronize one or more specific action outputs using one or more synchronization constraints;
maintain coherence among similar entities, wherein the coherence is maintained by comparing a first multi-dimensional content feature vector of a first digital content to a second multi-dimensional content feature vector of a second digital content;
optimize a utility function for one or more individual entities; and self-adjust, the reinforcement learning algorithm.

9. The system of claim 8, wherein the scaling out the API is a horizontal scaling of the API by deploying one or more additional API endpoints.

10. The system of claim 9, wherein forecasting number of users at a geographical location is performed by the machine learning engine using time series forecasting.

11. The system of claim 10, wherein the processor is further configured to receive the request at an API gateway and distributing set of requests to API endpoints by a load balancer.

12. The system of claim 11, wherein the processor is further configured to proactively perform the scale out and scale in operations based on the forecast of the number of users.

13. The system of claim 12, wherein the processor is further configured to proactively perform the scale out and scale in operations based on the forecast of the user traffic instead of forecast of the number of users.

14. The system of claim 13, wherein generating bills for a user based on the user traffic on the API.

15. One or more non-transitory computer readable media having instructions stored thereon, the instructions executable by a processor to cause the processor to:
receive, via the processor, a request to use the machine learning engine through an API interface, from a user from a plurality of users;
forecast, by the processor, number of users at a geographical location;
detect, by the processor, a surge in the number of users at the geographical location using the forecasted number of users;
upon detecting a surge in the number of users at the geographical location, scale, by the processor, out the API to handle additional load on the machine learning engine at the geographical location;
detect, by the processor, a drop in the number of users at the geographical location using the forecasted number of users;
upon detecting a drop in the number of users at the geographical location, scale, by the processor, in the API to reduce the resource utilization of machine learning engine at the geographical location; and
provide, by the processor, the machine learning engine service thorough the API interface, wherein the machine learning module is configured to:
determine set of parameters based on internet activities of a user in the plurality of categories, wherein the set of parameters are the content attributes associated with one or more user resonance and overall value ecosystem of a digital content economy;
learn the set of parameters to maximize the value function;
synchronize one or more specific action outputs using one or more synchronization constraints;
maintain coherence among similar entities, wherein the coherence is maintained by comparing a first multi-dimensional content feature vector of a first digital content to a second multi-dimensional content feature vector of a second digital content;
optimize a utility function for one or more individual entities; and
self-adjust, the reinforcement learning algorithm.

16. The non-transitory computer readable media of claim 15, wherein the scaling out the API is a horizontal scaling of the API by deploying one or more additional API endpoints.

17. The non-transitory computer readable media of claim 16, wherein forecasting number of users at a geographical location is performed by the machine learning engine using time series forecasting.

18. The non-transitory computer readable media of claim 17, wherein the processor is further configured to receive the request at an API gateway and distributing set of requests to API endpoints by a load balancer.

19. The non-transitory computer readable media of claim 18, wherein the processor is further configured to proactively perform the scale out and scale in operations based on the forecast of the number of users.

20. The non-transitory computer readable media of claim 19, wherein the processor is further configured to proactively perform the scale out and scale in operations based on the forecast of the user traffic instead of forecast of the number of users.
